(19) United States
(12) Patent Application Publication
(10) Pub. No.: US 2021/0348034 A1
(43) Pub. Date: Nov. 11, 2021

(54) FILM FOR APPLYING ONTO A TARGET OBJECT

(71) Applicant: PROFOL GMBH, Halfing (DE)

(72) Inventor: Christian HÜBNER, Halfing (DE)

(21) Appl. No.: 17/277,697

(22) PCT Filed: Sep. 19, 2019
(86) PCT No.: PCT/EP2019/075162

§ 371 Date: Mar. 18, 2021

(30) Foreign Application Priority Data
Sep. 19, 2018 (DE) 10 2018 215 927.0

(51) Int. Cl. C09J 7/29; B32B 7/12; B32B 27/20; B32B 27/32; B32B 27/08; C09J 7/24; C09J 7/38; C09J 11/04

(52) U.S. Cl. CPC C09J 7/29; C09J 2433/00; B32B 27/20; B32B 27/32; B32B 27/08; C09J 7/243; C09J 7/385; C09J 11/04; B32B 2307/732; B32B 2264/10; B32B 2264/303; B32B 2405/00; C09J 2301/122; C09J 2301/416; C09J 2423/046; C09J 2423/106; B32B 7/12

(57) ABSTRACT

A film for application onto a target object and comprising at least one cover layer and one adhesive layer, wherein the cover layer consists of a first polyolefin-based synthetic material having a first layer thickness, wherein the adhesive layer consists of a second polyolefin-based synthetic material having a second layer thickness which is less than the first layer thickness, and wherein the adhesive layer comprises an inorganic filler with a weight proportion greater than 20%.

### TECHNICAL FIELD

The present invention relates to a film for application onto a target object. The film can be applied onto the target object under the action of heat and/or pressure using a tool. In one preferred embodiment, the film is used to seal packaging for food—for example a yogurt pot.

### TECHNICAL BACKGROUND

In the field of packaging of, for example, food, the object is often to seal a target object in the form of a receptacle (for example, pot, bucket, barrel, etc.). It is known to provide such receptacles as a target object with a rim along the opening and to apply to this rim a lid made of a film for closure. The lid can be made of various materials and can also be applied using various methods. Methods that are on offer include, inter alio, bonding, pressing and welding. The selected materials and methods can then each provide certain advantages, but often also suffer from corresponding disadvantages, and therefore the selection of materials and methods for a particular intended use and purpose is often limited.

More recently, additional challenges have also arisen, in particular in the packaging of consumer goods (food, medicaments, cosmetics, consumables, etc.): For example, a specific varietal purity of the packaging as a whole is often necessary for sufficient recyclability. It is often required in this regard that both the receptacle (i.e. the target object in the form of, for example, a pot) and the seal (lid) are made of a sufficiently similar or even the same material so that easy recycling is possible for disposal. Nevertheless, other factors must be taken into account, in particular in the consumer goods sector. Good printability of the materials, compliance with hygiene regulations, and a satisfactory opening experience by the user should be mentioned at this point. The latter is particularly important for food products since the user, i.e. the consumer, should be given a safe feeling that, firstly, the receptacle was reliably closed before opening and, secondly, that the receptacle does not show any damage after opening and also that the seal was satisfactorily opened. This can relate to a complete removal of the lid and/or a good resealability.

With regard to the compliance with hygiene standards and regulations, it should be mentioned that as a result of filling and sealing of a food packaging, neither the outside of the packaging should be contaminated with the content (i.e. the food) nor the tools and equipment used for packaging should be contaminated with the content or goods to be filled. For example, residues outside the packaging not only leave an unclean impression but can also spoil and/or contaminate other goods. Contamination of the filling plant (including tool(s), holders, transport mechanisms, etc.) itself is also often undesirable, particularly if the goods to be filled are perishable food.

There is therefore a need for a technology that achieves the above objectives in the application of a film, particularly in connection with a packaging of goods to be filled. Consideration should thereby also be given to economic efficiency, reliability and an overall satisfactory compliance with all applicable standards. It is therefore a particular object of the present invention to provide a film with which one or more of the aforementioned objectives can be achieved.

### SUMMARY

The aforementioned problems and objects are solved by the subject matters of the independent patent claims. Further advantageous embodiments of the present invention are given in the dependent patent claims.

According to one embodiment of the present invention, a film is provided for application onto a target object and comprising at least one cover layer and one adhesive layer, wherein the cover layer consists of a first polyolefin-based synthetic material having a first layer thickness, wherein the adhesive layer consists of a second polyolefin-based synthetic material having a second layer thickness that is less than the first layer thickness, and wherein the adhesive layer comprises an inorganic filler with a weight proportion greater than 20%.

### BRIEF DESCRIPTION OF THE FIGURES

The embodiments of the present invention will be explained and illustrated in particular in connection with the following figures. The scope of protection should not be limited to this embodiment, and the figures and the corresponding description thus only serve to illustrate the general inventive concept. The enclosed figures show:

FIGS. 1A to 1D schematic sectional views of films according to corresponding embodiments of the present invention;

FIGS. 2A to 2C schematic views in connection with the use and advantages of films according to corresponding embodiments of the present invention;

FIG. 3 a schematic sectional view of a tool for applying a film according to one embodiment of the present invention; and

FIG. 4 schematically a use of a tool in applying a film according to one embodiment of the present invention onto a target object.

### DETAILED DESCRIPTION

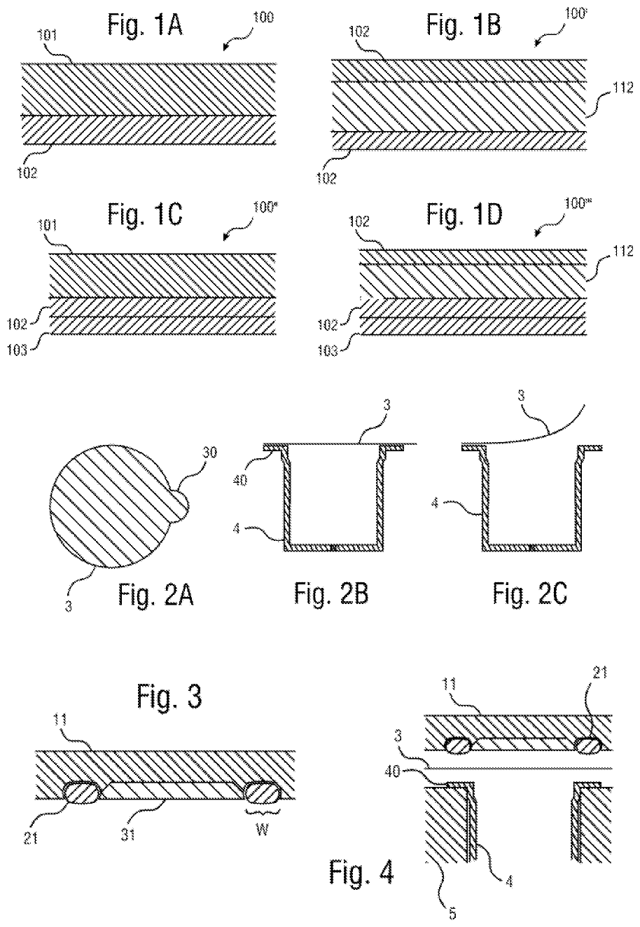

FIGS. 1A to 1D show schematic sectional views of films according to corresponding embodiments of the present invention. FIG. 1A shows a film 100 for application onto a target object. The film 100 comprises at least one cover layer 101 and one adhesive layer 102, wherein the cover layer 101 consists of a first polyolefin-based synthetic material having a first layer thickness, wherein the adhesive layer 102 consists of a second polyolefin-based synthetic material having a second layer thickness that is less than the first layer thickness, and wherein the adhesive layer 102 comprises an inorganic filler with a weight proportion greater than 20%. In another corresponding embodiment, the adhesive layer 102 has particles that can be excited by high-energy radiation. Preferably, these excitable particles can be present at a concentration in a range from 100 ppm to 300 ppm.

FIG. 1B shows a film 100′ for application onto a target object. The film 100′ comprises at least one top cover layer 102, one core layer 112, and one adhesive layer 102, wherein the cover layer 102 and/or the core layer 112 consists of a first polyolefin-based synthetic material and the top cover layer 102 forms a first layer thickness together with the core layer 112, wherein the adhesive layer 102 consists of a second polyolefin-based synthetic material having a second layer thickness that is less than the first layer thickness, and wherein the adhesive layer 102 comprises an inorganic filler with a weight proportion greater than 20%. In a further corresponding embodiment, the core layer 112 has particles which can be excited by high-energy radiation. Preferably, these excitable particles can be present at a concentration in a range from 50 ppm to 200 ppm.

FIG. 1C shows a film 100″ for application onto a target object. The film 100″ comprises at least one cover layer 101, one adhesive layer 102, and on the latter another adhesive layer 103. The cover layer 101 can consist of a polyolefin-based synthetic material having a first layer thickness, and adhesive layers 102, 103 can consist of a second polyolefin-based synthetic material having a respective layer thickness which, individually or together, can be less than the first layer thickness. The adhesive layer 102 can comprise an inorganic filler with a weight proportion greater than 20%. The further adhesive layer 103 can have a layer thickness in a range from 1 μm to 4 μm and can contain no filler compared to the adhesive layer 102, but can be made of the same base polymer as the adhesive layer 102.

FIG. 1D shows a film 100′″ for application onto a target object. The film 100″ can be considered a combination of the film 100′ described in connection with FIG. 1B and the film 100″ described in connection with FIG. 1C. Thus, the film 100″ comprises at least one cover layer 102, one core layer 112, one adhesive layer 102, and on the latter another adhesive layer 103. With regard to all other properties such as layer thickness, materials and fillers, the preferred embodiments according to the descriptions in connection with FIGS. 1A to 1C apply in each case. 1. In summary, this can result in a four-layer structure consisting of a cover layer, a core layer, the “first” adhesive layer as a separable or peelable separating/peel layer, and the “second” further adhesive layer as an inseparable or peelable sealing layer.

Generally, the cover layer(s) can have a layer thickness in a range from 70 μm to 105 μm and the adhesive layer can have a layer thickness in a range from 7 μm to 20 μm (preferably about 8 μm). If a multilayer cover layer is provided, such as shown in FIG. 1B, the top cover layer can have a thickness in a range from 10 μm to 20 μm, and the core layer can have a thickness in a range from 60 μm to 85 μm.

Generally, the polyolefin-based synthetic materials can each comprise polyethylene (PE) and/or polypropylene (PP), and the adhesive layer one or more acrylates. The inorganic filler can comprise particles of chalk, lime, talc, and/or platelet-shaped particles, wherein the diameter of the particles is in a range from 1 μm to 2 μm. The weight proportion of the inorganic filler can be in a range from 20% to 30%, and further preferably in a range from 25% to 50%.

FIGS. 2A to 2C show schematic views in connection with the use and advantages of films according to corresponding embodiments of the present invention. FIG. 2A shows a molded body 3 of a film according to one embodiment of the present invention from above. The molded body can serve as a seal lid of a receptacle, for example as part of a food packaging, and thus can have a tab 30 that facilitates removal of the lid.

As shown in FIG. 2B, the molded body can form a lid 3 for a pot 4, wherein the film of the lid 3 has been applied to a rim 40 of the pot 4—as an exemplary target object. This application can include welding with a tool. The properties of the film according to the embodiments of the present invention allow the lid to be applied onto the target object in such a manner that no contamination occurs in and around a sealing area. Furthermore, as shown in FIG. 2C, the film can be easily peeled off the target object without tools and without leaving any residue (“peelable”). These advantages can be achieved in particular by the preferred selection of the filler or fillers, and the concentration thereof, in the adhesive layer 102. In particular, a residue-free removal achieves a satisfactory opening experience, i.e. the user experiences the sensation of a reliable seal and an appropriate opening. This moreover also shows, further advantageously, that the sealing point does not or did not contain any leaks or contamination (for example, by the goods or food to be packaged). A satisfactory and reliable resealing is also made possible.

FIG. 3 shows a schematic sectional view of a corresponding tool for applying a film according to one embodiment of the present invention. A tool 1 is used to apply a film onto a target object under the action of heat and/or pressure. The tool 1 comprises a support 11 of a first material and a bar 21 of a second, elastic material, wherein the bar 21 is arranged on the support 11 and has at least one area W that is curved outwards. This can reveal a circular or elliptical basic shape which can be described by one or more radii.

The first material of the support 11 is preferably a metal such as aluminum, copper, an aluminum alloy, a copper alloy, brass, bronze, Amcorloy, or steel. In embodiments where the tool is used to apply a film onto a target object under the action of heat, the first material should have sufficient or the desired heat conductivity or heat capacity. If welding, i.e. at least a partial melting of the film and, if needed, parts of the target object, is desired, sufficient heat conduction is required to conduct the necessary melting heat within the desired time from a heater or heat source (not shown) to the curved area of the bar.

The second material of the bar is preferably a high temperature resistant silicone or another elastomer of Shore A hardness between 50 and 80. The second material can further comprise a composite material having one or more fillers in a support material (aforementioned silicone/elastomer), which are used in particular to increase the heat conductivity and/or the specific heat capacity while maintaining the mechanical strength. In such embodiments, heat input and pressure transmission can thus be adapted to the film and/or the material of the target object in the area of a seal.

The support of the first material not only provides mechanical stability but also carries the required heat to the area of the bar that is curved outwards. This area can therefore be pressed onto a film and an area (for example rim of a pot, see below for details in connection with FIG. 4) of the target object, wherein the required heat is supplied to the sealing area. The curvature to the outside (crowning) preferably enables an initial linear contact. As the tool is further advanced onto the film, the outwardly curved area of the bar is pressed onto the film, wherein the mechanical contact area progressively increases in both directions away from the initial line. Thus, any impurities on the film or on the sealing rim of the target object can be advantageously pressed out or pressed away. As a result, it can be ensured also in the area of critical packaging (hygiene-critical packaging such as in the area of food packaging) that impurities or residues of the goods to be filled adversely affect the adhesion or bond of the film onto the target object. The bar 21 can generally be configured ring-shaped or circular.

The tool 11 can further comprise an inner support 31 of a third material. This third material can be the same as the aforementioned first material, or any of the following materials, or any combination of more than one of the following materials: Machinable ceramics, ceramics, glass fiber reinforced ceramics, glass fiber reinforced plastics (GFRP), high temperature resistant and/or foamed synthetic materials, foamed silicates (aerogels), foam glass, and any other thermally and mechanically resistant insulating material. Moreover, the third material and/or the inner support can be provided at least partially with a coating for achieving food compliance. Further preferably, the third material has a continuous service temperature of at least 250° C.

FIG. 4 schematically shows a use of the tool in applying a film according to one embodiment of the present invention onto a target object. As shown, a tool 11 is supposed to apply a film 3 onto a target object, for example a pot 4, under the action of heat and pressure. For this purpose, the target object (for example, a container for a food product such as a yogurt pot) is inserted into a holder 5. A rim 40 of the pot 4 rests on this holder 5, and the film 3 can thus be pressed onto the rim 40 using the tool 11. For this purpose, the bar 21 of the tool 11 is brought to or maintained at a target temperature and moved to the rim 40 under a well-defined or controlled pressure. In the course of this, the film 3 is applied onto the target object in the area of the rim 30 by pressing, welding and/or otherwise joining the materials of the film 3 and the rim 40. In particular, the adhesive layer 102 of the film 100, 100′, 3 thereby comes into contact with the material of the target object (here, for example, the rim 40 of the pot 4), and the film can be bonded to the target object in a peelable, resealable and reliable manner.

Although detailed embodiments of the invention have now been described, these should only serve for a better understanding of the invention and its effects. The scope of protection is defined by the following claims and should not be limited by the detailed description.

1. Film for application onto a target object and comprising at least one cover layer and one adhesive layer, wherein the cover layer consists of a first polyolefin-based synthetic material having a first layer thickness, wherein the adhesive layer consists of a second polyolefin-based synthetic material having a second layer thickness which is less than the first layer thickness, and wherein the adhesive layer comprises an inorganic filler with a weight proportion of greater than 20%.

2. A film according to claim 1, wherein the cover layer has a layer thickness in a range from 70 μm to 105 μm.

3. A film according to claim 1 or 2, wherein the adhesive layer has a layer thickness in a range from 7 μm to 20 μm.

4. A film according to one of claims 1 to 3, wherein the cover layer is a top cover layer and the film comprises at least one core layer.

5. A film according to one of claims 1 to 4, wherein the film comprises a further adhesive layer on the adhesive layer.

6. A film according to claim 5, wherein the further adhesive layer has a layer thickness in a range from 1 μm to 4 μm.

7. A film according to claim 5 or 6, wherein the further adhesive layer does not comprise a filler and/or is made of the same second polyolefin-based synthetic material.

8. A film according to one of claims 4 to 7, wherein the top cover layer has a layer thickness in a range from 10 μm to 20 μm, and the core layer has a layer thickness in a range from 60 μm to 85 μm.

9. A film according to claim 8, wherein the core layer contains particles which can be excited by high-energy radiation.

10. A film according to one of claims 1 to 9, wherein the polyolefin-based synthetic material comprises polyethylene, PE, and/or polypropylene, PP.

11. A film according to one of claims 1 to 10, wherein the adhesive layer comprises one or more acrylates.

12. A film according to one of claims 1 to 11, wherein the inorganic filler comprises particles of chalk, lime, talc, and/or platelet-shaped particles.

13. A film according to one of claims 1 to 12, wherein the adhesive layer comprises particles that can be excited by high-energy radiation.

14. A film according to one of claims 1 to 13, wherein the diameter of the particles is in a range from 1 μm to 2 μm.

15. A film according to one of claims 1 to 14, wherein the weight proportion of the inorganic filler is in a range from 20% to 30% and, further preferably, in a range from 25% to 50%.
